(19) United States
(12) Patent Application Publication
(10) Pub. No.: US 2024/0318052 A1
(43) Pub. Date: Sep. 26, 2024

(54) METHOD OF UNDERWATER BONDING

(71) Applicant: Henkel AG & Co. KGaA, Duesseldorf (DE)

(72) Inventors: Gavin Haberlin, Naas (IE); Michael Jordan, Dublin (IE); Susan Reilly, Clane (IE); Emer Ward, Dublin (IE)

(21) Appl. No.: 18/731,870

(22) Filed: Jun. 3, 2024

Related U.S. Application Data
(63) Continuation of application No. PCT/EP2022/084306, filed on Dec. 2, 2022.

(30) Foreign Application Priority Data
Dec. 3, 2021 (GB) 2117520.3

(51) Int. Cl. C09J 133/08; C09J 9/00; C09J 11/06; C09J 11/08

(52) U.S. Cl. CPC C09J 133/08; C09J 9/00; C09J 11/06; C09J 11/08

(57) ABSTRACT

A method of bonding substrates that are underwater comprising applying, underwater, a cyanoacrylate composition to at least one substrate and allowing the composition to cure underwater.

### FIELD

The present invention provides a method of underwater bonding by curable cyanoacrylate compositions.

### Brief Description of Related Technology

Curable compositions such as cyanoacrylate adhesives are well recognized for their excellent ability to rapidly bond a wide range of substrates, generally in a number of minutes and depending on the particular substrate, often in a number of seconds.

Cyanoacrylate adhesive compositions are well known, and widely used as quick setting, instant adhesives with a wide variety of uses. See H. V. Coover, D. W. Dreifus and J. T. O'Connor, “Cyanoacrylate Adhesives” in Handbook of Adhesives, 27, 463-77, I. Skeist, ed., Van Nostrand Reinhold, New York, 3rd ed. (1990). See also G. H. Millet, “Cyanoacrylate Adhesives” in Structural Adhesives: Chemistry and Technology, S. R. Hartshorn, ed., Plenum Press, New York, p. 249-307 (1986).

Cyanoacrylates adhesive compositions are well suited to curing in air. Beneficially these compositions achieve handling strength in seconds when cured in air and >60% strength within 1 minute when cured in air.

Polymerization of cyanoacrylates is initiated by nucleophiles found under normal atmospheric conditions on most surfaces. The initiation by surface chemistry means that sufficient initiating species are available when two surfaces are in close contact with a small layer of cyanoacrylate between the two surfaces. Under these conditions a strong bond is obtained in a short period of time. Thus, in essence the cyanoacrylate often functions as an instant adhesive.

Cyanoacrylate adhesive compositions are not traditionally used for underwater applications because cyanoacrylate adhesive compositions are difficult to dispense underwater. It will be appreciated that underwater means that the substrates to be bonded are completely submerged in water. The water is in contact with the substrates. Underwater as used herein does not refer to a situation where the substrates are underwater but not in contact with the water, for example underwater does not refer to substrates which are placed in a waterproof container and this container is in contact with water while the substrate are not in contact with water as the waterproof container keeps them dry. In particular the present invention is concerned with methods employing cyanoacrylate adhesive which is dispensed from a container while underwater. In such cases the cyanoacrylate adhesive is dispensed through the water onto a substrate surface and that substrate surface is also in contact with water.

Dispensing cyanoacrylate adhesive compositions underwater causes the composition to react with the water and the compositions may prematurely cure prior to being applied to the substrates it is intended to bond. Indeed cyanoacrylate compositions are well known to be sensitive to water and in some cases even trace amounts of water can cause premature cure for example during storage for later use.

Cyanoacrylate adhesive performance, particularly durability, oftentimes becomes suspect when exposed to water. A bond formed using cured cyanoacrylate compositions can be susceptible to water. For example the bond formed may ultimately fail due to degradation of the cured cyanoacrylate composition over time when exposed to water. In general exposure to water causes loss of bond strength over time.

Cyanoacrylate adhesive compositions when dispensed underwater may also partially cure when it is applied to a first substrate but prior to joining to a second substrate. While it may be possible in this case to form a bond between the substrates the bond will be weak as the composition has partially part cured before the substrates are jointed.

To overcome these issues typically cyanoacrylate adhesive compositions may be applied to substrates in air and then the bonded substrates are placed underwater.

Underwater bonding using cyanoacrylate adhesive compositions would be advantageous for applications where the properties of cyanoacrylate adhesive compositions would be beneficial. In situations where it is difficult to remove the substrates from water it would be beneficial to both dispense and to cure a cyanoacrylate adhesive composition underwater. For example when performing boat repairs or maintenance or fitting new parts, such as sensors, to boats it would be beneficial to use a cyanoacrylate adhesive composition for bonding parts of the boat which are underwater to eliminate the need to remove the boat from the water, which can be challenging and expensive and requires the ship to return to land. Similarly, it would be useful to be able to perform underwater maintenance and repairs or to fit parts to structures which are wholly or partially underwater, such as oil rig apparatus, bridges, pipelines, etc.

Coral reefs are formed by colonies of coral polyps. The skeletons of the coral polyps are formed from calcium carbonate and the coral polyps are held together by their calcium carbonate skeletons. The majority of coral reefs are built by stony corals polyps also called Scleractinia. Stony corals secrete hard calcium carbonate exoskeletons which protect and support the coral reef. Coral reefs can be damaged by, for example excess nutrients or oceanic acidification. Coral transplantation is considered a viable method of assisting coral reefs to recover from damage. Healthy coral polyps are transplanted from healthy reefs to damaged reefs. Healthy polyps may assist in repair of the coral reef. The transplanted coral polyps are secured to their new location using cement or epoxy. If the transplanted coral polyps detach from where they have been transplanted to the coral polyps will die and the transplantation is not successful. In these methods the dispensing, applying, and curing of the epoxy can take a long time. This means that the user, often a diver, must spend extended periods of time underwater, which is expensive and can be dangerous.

Dizon et al compared the use of a cyanoacrylate adhesive gel composition, an epoxy putty, and a marine epoxy to determine their suitability for attachment of coral polyps. Dizon et al applied the cyanoacrylate adhesive composition above water and subsequently submerged the coral polyp underwater. Dizon et al found that while the cyanoacrylate adhesive compositions were the easiest to handle they rated poorly in the critical areas of effectiveness of attachment and transplant self-attachment.

It would be beneficial to provide an adhesive composition which has the benefits of a cyanoacrylate composition and is effective in attaching coral polyps during transplantation.

It would be beneficial to provide alternative adhesives which can: (1) be dispensed while submerged, (2) remain uncured for sufficient time to allow application to a substrate to be bonded; (3) subsequently cure, desirably with a short cure time (4) develop high strength bonds, and (5) retain bond strength. All of the foregoing need to be achieved underwater.

### SUMMARY

In one aspect, the present invention provides a method of bonding substrates that are underwater comprising: applying, underwater, a cyanoacrylate composition to at least one substrate, wherein the cyanoacrylate composition comprises a first part comprising:

a cyanoacrylate component and a rubber toughening agent, the rubber toughening agent comprised of i) reaction products of the combination of ethylene, methyl acrylate and monomers having carboxylic acid cure sites, (ii) dipolymers of ethylene and methyl acrylate, and combinations of (i) and (ii); and a second part comprising a 2-substituted benzothiazole or derivative thereof, wherein the 2-substituent is a C₁₋₂₀ alkyl, a C₂₋₂₀ alkene, a C₈₋₂₀ alkylbenzyl, a C₁₋₂₀ alkylamino, a C₁₋₂₀ alkoxy, a C₁₋₂₀ alkylhydroxy, an ether, a sulfenamide, a C₁₋₂₀ thioalkyl or a C₁₋₂₀ thioalkoxy group; and wherein at least one of the first or second part further comprises a component containing at least two (meth)acrylate functional groups, at least one benzonitrile compound substituted with at least two or more electron withdrawing groups selected from halo, —NO₂, or —CN and combinations thereof, and at least one anhydride component, and allowing the composition to cure underwater.

Underwater means that the substrates are submerged in water so that the water is in contact with the substrates at the same time as the composition is applied. The substrates are not, for example, in a water proof container so that they are not directly exposed to the water. Beneficially the method allows bonding underwater in applications traditionally excluded due to an inability to remove and dry the assembly before bonding.

Beneficially the composition applied in the method can be dispensed while submerged, remains uncured for sufficient time to allow application to a substrate to be bonded; and subsequently cures with a short cure time. Beneficially the cured composition which was allowed to cure underwater develops high strength bonds, and retains that bond strength over time. Desirably the composition has a sufficiently long open time so that it can be dispensed, applied, and the substrate (s) bonded before the composition cures, but a faster cure time than compositions used in previous methods in order to minimise the time that the user must spend underwater.

The perceived shortcomings of cyanoacrylate compositions for bonding substrates that are underwater may be overcome with the cyanoacrylate hybrid composition disclosed herein. All of the desirable properties of the present invention refer to those properties of the composition in an underwater environment. Compositions of the invention remain in place when dispensed. Compositions of the method can be dispensed underwater, for example there is no premature cure upon first contact with water which would prevent dispensing of the composition onto a substrate. Compositions of the method must have a suitable viscosity to allow them to be dispensed. The compositions may have a suitable buoyancy. For example it is appropriate that a composition of the method is not moved out of position by the forces caused by normal water currents.

The composition may be dispensed underwater and used in a method of bonding substrates that are underwater. While not wishing to be bound by a theory it is thought that, a combination of cure speed modulation due to the acrylate portion of the component containing at least two (meth)acrylate functional groups and the material's inherent high viscosity, may impart this unexpected open time in an aqueous environment. The first part of the composition may have a Casson viscosity of from 200 to 600 mPa·s. The second part may have a viscosity of from 1 to 20 mPa·s as measured according to BS 5350 Part B8.

The cyanoacrylate component of the cyanoacrylate composition applied in the method may be selected from materials within the structure H₂C═C(CN)—COOR, wherein R is selected from C₁₋₁₅ alkyl, C₂₋₁₅ alkoxyalkyl, C₃₋₁₅ cycloalkyl, C₂₋₁₅ alkenyl, C₆₋₁₅ aralkyl, C₅₋₁₅ aryl, C₃₋₁₅ allyl and C₁₋₁₅ haloalkyl groups, for example wherein the cyanoacrylate component comprises ethyl-2-cyanoacrylate.

The 2-substituted benzothiazole of the cyanoacrylate composition may be further substituted with at least one halo, C₁₋₂₀ thioalkyl, C₁₋₂₀ haloalkyl, C₁₋₂₀ alkyl, C₁₋₂₀ alkoxy or hydroxyl substituent.

The halo substituent of the cyanoacrylate composition may be Cl, F or Br.

The 2-substituted benzothiazole of the cyanoacrylate composition may be selected from the group consisting of: 5-chloro-2-methyl benzothiazole, 5-bromo-2-methyl-1,3-benzothiazole, 2-[(tert-butylamino)thio]-1,3-benzothiazol-5-ol, 5,6-dichloro-2-methyl-1,3-benzothiazole, 6-bromo-2-methyl-1,3-benzothiazole, 5-fluoro-2-methyl-1,3-benzothiazole, 6,7-dichloro-2-methyl-1,3-benzothiazole, 2,5-dimethyl-1,3-benzothiazole, 4, 5, 6, 7-tetrafluoro-2-methyl-1,3-benzothiazole, 4, 5, 6, 7-tetrafluoro-2-methyl-1,3-benzothiazole, 2-(allyloxy)-1,3-benzothiazole 2-methyl-5-(methylthio)-1,3-benzothiazole, 2-(ethylthio)-1,3-benzothiazole, 2-(hexyloxy)-1,3-benzothiazole, 2-(1,3-dimethylbutoxy)-1,3-benzothiazole, 2-(Octadecylthio) benzothiazole, 2-(1-ethylbutoxy)-1,3-benzothiazole, 2-(octyloxy)-1,3-benzothiazole, 2-(1-methylbutoxy)-1,3-benzothiazole, 2-(2-phenylethoxy)-1,3-benzothiazole, 2-[(1-methylheptyl)oxy]-1,3-benzothiazole 2-allyl-1,3-benzothiazole, 2-[(1-methylhexyl)oxy]-1,3-benzothiazole, 4-chloro-2-methoxy-1,3-benzothiazole, 2-(3-methylbutoxy)-1,3-benzothiazole, 4-chloro-2-(ethynyloxy)-1,3-benzothiazole, 2, 5,6-trimethyl-1,3-benzothiazole, 4-methoxy-2,7-dimethyl-1,3-benzothiazole, 5,6-dimethoxy-2-methyl-1,3-benzothiazole, 2,5,7-trimethyl-1,3-benzothiazole, 2-(butylthio)-1,3-benzothiazole, 5-chloro-2-(ethylthio)-1,3-benzothiazole, 2-methyl-1,3-benzothiazole, 2-(undecylthio)-1,3-benzothiazole, 2-methyl-1,3-benzothiazole 5-methoxy-2-methylbenzothiazole, 2,5-dimethylbenzothiazole 6-methoxy-2-methylbenzothiazole, 2-methyl-5-benzothiazolol, 2-(methylmercapto)-benzothiazole, and 2-[(cyclohexylamino)thio]-benzothiazole), preferably wherein the 2-substituted benzothiazole is selected from the group consisting of: 5-chloro-2-methyl benzothiazole, 2-methyl-1,3-benzothiazole, 2-(methylmercapto)-benzothiazole, 5-methoxy-2-methylbenzothiazole, 6-methoxybenzothiazole, 2,5-dimethylbenzothiazole and 2-methyl-5-benzothiazolol.

The component containing at least two (meth)acrylate functional groups of the cyanoacrylate composition may be represented by the formula:

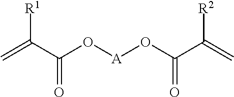

wherein A is a C₄ to C₃₀ aliphatic chain which can optionally comprise heteroatoms selected from the group consisting of 0, N and S;

wherein said chain is optionally substituted with one or more acrylate or methacrylate functional groups, and/or one or more C₁-C₁₀ alkyl groups; and wherein R¹ and Re may be the same or different and are each optionally selected from the group consisting of H and C₁ to C₆ alkyl.

The component containing at least two (meth)acrylate functional groups of the cyanoacrylate composition may be selected from the group consisting of hexane diol diacrylate, hexane diol dimethacrylate, and di-trimethylolpropane tetraacrylate and combinations thereof.

The component containing at least two (meth)acrylate functional groups of the cyanoacrylate composition may be in the second part (b).

The anhydride component of the cyanoacrylate composition may be selected from the group consisting of: phthalic anhydride, tetrahydrophthalic anhydride, 4-methylphthalic anhydride, itaconic anhydride, diphenic anhydride, phenylsuccinic anhydride, 1,8 naphthalic anhydride, bromomaleic anhydride, 2,3-dichloromaleic anhydride, 2-dodecen-1-yl-succinic anhydride, homophthalic anhydride, tetrabromophthalic anhydride, bicyclo[2,2,2]oct-7-ene 2, 3, 5,6-tetracarboxylic dianhydride, 3-fluorophthalic anhydride, 3, 3, 4,4-benzophenone tetracarboxylic dianhydride, 3-nitrophthalic anhydride, 3, 3, 4,4-biphenyltetracarboxylic dianhydride, pyromellitic dianhydride, 1, 4,5,8 naphthalene tetracarboxylic dianhydride, methacrylic anhydride, citraconic anhydride, hexahydro-4-methylphthalic anhydride, maleic anhydride, 2,3-diphenylmaleic anhydride, hexafluoroglutaric anhydride, 2,3-dimethylmaleic anhydride, tetrafluorophthalic anhydride, 1,2-cyclohexanedicarboxylic anhydride, glutaric anhydride, bromomaleic anhydride, 1,4,5,8-naphthalenetetracarboxylicacid dianhydride, 1, 2,4-benzenetricarboxylic anhydride, Exo-3,6-epoxy-1, 2, 3, 6-tetrahydrophthalic anhydride, di-O-acetyl-L-tartaric anhydride, 1, 2, 4,5-benzenetetracarboxylic dianhydride, 1, 2,4-benzenetricarboxylic anhydride and combinations thereof.

The benzonitrile compound of the cyanoacrylate composition may be selected from the group consisting of: tetrafluoroisophthalonitrile, 3,5-dinitrobenzonitrile; 2-chloro-3,5-dinitrobenzonitrile; pentafluorobenzonitrile; α,α,α-2-tetrafluoro-p-tolunitrile; and tetrachloroterephthalonitrile and combinations thereof.

The benzonitrile compound of the cyanoacrylate composition may be present in an amount of from 0.05 to 5 wt %, preferably in an amount of from 0.1 to 1 wt % based on the total weight of the composition.

The anhydride component of the cyanoacrylate composition may be present in an amount of from 0.1 to 5 wt %, preferably in an amount of from 0.1 to 2 wt % based on the total weight of the composition.

The component containing at least two (meth)acrylate functional groups of the cyanoacrylate composition may be present in an amount of from 1 to 20 wt %, preferably in an amount of from 4 to 12 wt % based on the total weight of the composition.

The 2-substituted benzothiazole of the cyanoacrylate composition may be 5-chloro-2-methyl benzothiazole, the anhydride may be selected from the group consisting of phthalic anhydride, tetrahydrophthalic anhydride, itaconic anhydride or 4-methylphthalic anhydride and combinations thereof, and wherein the at least one benzonitrile compound may be selected from the group consisting of tetrafluoroisophthalonitrile or pentafluorobenzonitrile and combinations thereof.

The benzonitrile of the cyanoacrylate composition may be present in an amount of from 0.1 to 1 wt %, the anhydride may be present in an amount of from 0.1 to 2 wt %, and the component containing at least two (meth)acrylate functional groups may be present in an amount of from 4 to 12 wt %, based on the total weight of the composition.

The cyanoacrylate composition optionally further comprises an accelerator component may be selected from the group consisting of calixarene, oxacalixarene, silacrown, cyclodextrin, crown ether, poly(ethyleneglycol)di(meth)acrylate, ethoxylated hydric compound, and combinations thereof.

The accelerator component may comprise a calixarene which is tetrabutyl tetra[2-ethoxy-2-oxoethoxy]calix-4-arene.

The accelerator component may comprise a crown ether which is selected from the group consisting of 15-crown-5,18-crown-6, dibenzo-18-crown-6, benzo-15-crown-5-dibenzo-24-crown-8, dibenzo-30-crown-10, tribenzo-18-crown-6, asym-dibenzo-22-crown-6, dibenzo-14-crown-4, dicyclohexyl-18-crown-6, dicyclohexyl-24-crown-8, cyclohexyl-12-crown-4, 1,2-decalyl-15-crown-5, 1,2-naphtho-15-crown-5, 3, 4,5-naphtyl-16-crown-5, 1,2-methyl-benzo-18-crown-6, 1,2-methylbenzo-5,6-methylbenzo-18-crown-6, 1,2-t-butyl-18-crown-6, 1,2-vinylbenzo-15-crown-5, 1,2-vinylbenzo-18-crown-6, 1,2-t-butyl-cyclohexyl-18-crown-6, asym-dibenzo-22-crown-6, and 1,2-benzo-1,4-benzo-5-oxygen-20-crown-7 and combinations thereof.

The accelerator component may comprise a poly(ethyleneglycol) di(meth)acrylate which is within the following structure:

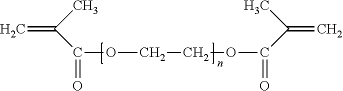

wherein n is greater than 3.

The cyanoacrylate component may further comprise additives selected from the group consisting of: shock resistant conferring additives, thixotropy conferring agents, thickeners, dyes, thermal degradation resistance enhancers, and combinations thereof.

The shock resistant conferring additive may be citric acid.

The cyanoacrylate component may further comprise at least one additive selected from the group consisting of: 2-sulfobenzoic acid anhydride, triethylene glycol di(paratoluene sulfonate), trifluoroethyl para-toluene sulfonate, dimethyl dioxolen-4-ylmethyl para-toluene sulfonate, paratoluene sulfonic anhydride, methane sulfonic anhydride, 1,3-propylene sulfite, dioxathiolane dioxide, 1,8-naphthosultone, sultone 1,3-propane, sultone 1,4-butene, allyl phenyl sulfone, 4-fluorophenyl sulfone, dibenzothiophene sulfone, bis(4-fluorophenyl) sulfone, ethyl p-toluenesulfonate, trifluoromethanesulfonic anhydride, ethylene sulphite and combinations thereof.

The additive may be selected from 1,8-naphthosultone and ethylene sulphite, and combinations thereof.

In another aspect the invention relates to a method of bonding substrates that are underwater comprising: applying, underwater, a cyanoacrylate composition to at least one substrate, wherein the cyanoacrylate composition comprises: a first part comprising a cyanoacrylate component and a rubber toughening agent, the rubber toughening agent being comprised of (i) reaction products of the combination of ethylene, methyl acrylate and monomers having carboxylic acid cure sites, (ii) dipolymers of ethylene and methyl acrylate, and combinations of (i) and (ii); and
a second part comprising a 2-substituted benzothiazole or derivative thereof, wherein the 2-substituent is a C₁₋₂₀ alkyl, a C₂₋₂₀ alkene, a C₈-C₂₀ alkylbenzyl, a C₁₋₂₀ alkylamino, a C₁₋₂₀ alkoxy, a C₁₋₂₀ alkylhydroxy, an ether, a sulfenamide, a C₁-C₂₀ thioalkyl or a C₁₋₂₀ thioalkoxy group; and
wherein at least one of the first or second part further comprises an anhydride component; and
wherein the second part further comprises a component containing at least two (meth)acrylate functional groups which is present in an amount of from 1 to 20 wt %, preferably in an amount of from 4 to 12 wt %, based on the total weight of the composition; and at least one benzonitrile compound substituted with at least two or more electron withdrawing groups selected from halo, —NO—, or —CN and combinations thereof, and
allowing the composition to cure underwater.

The 2-substituted benzothiazole of the cyanoacrylate composition may be selected from the group consisting of: 5-chloro-2-methyl benzothiazole, 2-methyl-1,3-benzothiazole, 2-(methylmercapto)-benzothiazole, 5-methoxy-2-methylbenzothiazole, 6-methoxybenzothiazole, 2,5-dimethylbenzothiazole and 2-methyl-5-benzothiazolol and combinations thereof;
The anhydride component of the cyanoacrylate composition may be selected from the group consisting of:
tetrafluoroisophthalonitrile, 3,5-dinitrobenzonitrile; 2-chloro-3,5-dinitrobenzonitrile; pentafluorobenzonitrile; a, a, α-2-tetrafluoro-p-tolunitrile; and tetrachloroterephthalonitrile and combinations thereof.

The component containing at least two (meth)acrylate functional groups of the cyanoacrylate composition may be selected from the group consisting of hexanediol diacrylate, hexanediol dimethacrylate, and di-trimethylolpropane tetraacrylate and combinations thereof.

The cyanoacrylate composition may be applied wherein a ratio of the first part to second part of the cyanoacrylate composition in the range of about 1:1 to about 10:1, for example 2:1 or 3:1 or 4:1, or 5:1 or 6:1 or 7:1 or 8:1 or 9:1.

The cyanoacrylate composition may be applied in a ratio of the first part to second part of about a 10:1 ratio.

The component containing at least two (meth)acrylate functional groups of the cyanoacrylate composition may be used as a carrier material for the at least one benzonitrile compound.

The method of bonding substrates that are underwater may comprise exposing the composition to water for up to 45 seconds prior to joining the surface of the second substrate with the coated surface of the first substrate. This may be referred to as the open time of the composition. The composition may have a good open time of up to 90 seconds, for example up to 60 seconds, for example up to 45 seconds. Beneficially a good open time allows time for the substrates to be correctly mated prior to the composition curing. The substrates can be assembled into an assembly in the correct configuration as the good open time allows time for assembly. The composition has a good open time and allows for nozzles (through which the composition is dispensed to be applied) to be changed underwater without the composition curing. The composition may form a film in the topmost layer of the film but does not cure in the bulk and has good open time.

In the method of bonding substrates that are underwater the composition does not mix with the water, for example in a water column, or otherwise disperse in water. The physical properties of the composition, for example its viscosity, are such that it does not mix with the water and stays where it is applied. The outermost layer of the composition may cure to form a film which prevents the bulk of the composition from coming into contact with the water. In this respect, cure through volume of the composition can occur later after two substrates are brought together.

The method of bonding substrates that are underwater may comprise curing the composition which can form a bond with a shear strength, as measured according to ASTM D1002, of at least 0.6 N/mm² after curing for five minutes, for example after curing for 24 hours, for example after 168 hours. For example, when at least one substrate may comprise calcium carbonate, for example may be formed, wholly or partially, from calcium carbonate.

In the method of bonding substrates that are underwater curing the composition forms a bond with a shear strength, as measured according to ASTM D1002, of at least 4 N/mm-after curing for five minutes, for example after curing for 24 hours, for example after 168 hours. For example, when at least one substrate is formed from a metal, for example steel.

In the method of the invention one or both substrates may be naturally occurring and/or or man-made.

Naturally occurring substrates include coral substrates such as coral reefs. Coral reefs are formed by colonies of coral polyps. Calcium carbonate substrates may be bonded with the method of the present invention. These substrates include coral substrates such as calcium carbonate substrates including calcium carbonate skeletons of a coral substrate. For example a method of the invention may be used to repair breakages in a coral formation and/or to add coral materials to a coral formation.

In the method of bonding substrates that are underwater one or both substrates may be a metal, for example wherein one or both substrates may be steel.

In the method of bonding substrates that are underwater at least one substrate may comprise a material selected from the group comprising: steel, aluminium, wood, fibreglass, a building material including aggregates, sand, concrete/cement materials including ferrocements, fibre-reinforced plastic.

Suitably, both substrates may independently comprise a material selected from the group comprising: steel, aluminium, wood, fibreglass, a building material including aggregates, sand, concrete/cement materials including ferrocements, fibre-reinforced plastic.

In the method of bonding substrates that are underwater at least one substrate may be a watercraft, such as a boat or a ship, or a part thereof. The method may be used for affixing items to boats or ships, for example fitting sensors or attaching replacement parts, or for performing repairs on boats or ships. With the method of the invention this can be carried out without needing to return to land to remove the boat or ship from the water.

In the method of bonding substrates that are underwater at least one substrate may be a structure which is located underwater or a part of a structure which extends underwater, such as a bridge, oil or gas rig apparatus, pipeline, dam, wind turbine or similar. Such structures cannot be removed from the water so it is beneficial to be able to be able to affix items, for example accessories, sensors or replacement parts, or to perform repairs while underwater.

In the method of bonding substrates that are underwater one or both substrates may comprise calcium carbonate, for example may be formed, wholly or partially, from calcium carbonate, for example wherein one or both substrates is a shell, for example wherein one or both substrates is a scleractinia shell.

In the method of bonding substrates that are underwater the nozzle life may be at least 4 minutes, for example at least 5 minutes. The dispense nozzles have good nozzle life because the composition does not prematurely cure and block the nozzle. This is surprising as compositions comprising cyanoacrylate typically experience fast cure when exposed to moisture, for example when they are underwater. Beneficially the nozzle life is increased and thus allows more of the composition to be applied before the nozzle has to be changed.

The method of bonding substrates that are underwater may be carried out in water containing varying amounts of salts and/or minerals. For example, the method may be carried out in distilled water, or treated water such as in a public/mains water supply. The method may be carried out in freshwater such as in wells, rivers or lakes. The method may be carried out in saltwater, for example in seawater, for example in water having a salinity of from about 30 g/L to about 50 g/L.

The method of bonding substrates that are underwater may be carried out in water having a pH in the range of from about 6 to about 9, for example from about 6.5 to about 8 or from about 7.5 to about 8.5.

In another aspect the invention relates to an assembly comprising two underwater substrates that are bonded together by method of the invention

### DETAILED DESCRIPTION

The method of bonding substrates that are underwater comprises applying, underwater, a cyanoacrylate composition which is described in detail below.

The cyanoacrylate component of the method of the includes at least one cyanoacrylate monomer which may be chosen with a raft of substituents, such as those represented by H2C═C(CN)—COOR, where R is selected from C₁₋₁₅ alkyl, C₂₋₁₅ alkoxyalkyl, C₃₋₁₅ cycloalkyl, C₂₋₁₅ alkenyl, C₆₋₁₅ aralkyl, C₅₋₁₅ aryl, C₂₋₁₅ allyl and haloalkyl groups. Desirably, the cyanoacrylate monomer is selected from at least one of methyl cyanoacrylate, ethyl-2-cyanoacrylate, propyl cyanoacrylates, butyl cyanoacrylates (such as n-butyl-2-cyanoacrylate), octyl cyanoacrylates, allyl cyanoacrylate, ß-methoxyethyl cyanoacrylate and combinations thereof. A particularly desirable cyanoacrylate monomer includes ethyl-2-cyanoacrylate.

The cyanoacrylate component may be included in the compositions of the method of the invention in an amount within the range of from about 50% to about 99.98% by weight, with the range of about 70% to about 85% by weight, of the total composition being desirable.

The rubber toughening component may be chosen from one of several possibilities. One such possibility is a reaction product of the combination of ethylene, methyl acrylate and monomers having carboxylic acid cure sites. For example, the rubber toughening component may be an ethylene acrylic acid elastomer such as those available from Dupont™ under the trade name VAMAC, such as VAMAC N123 and VAMAC B-124. VAMAC N123 and VAMAC B-124 are reported by DuPont to be a master batch of ethylene/acrylic elastomer. The DuPont material VAMAC G is a similar copolymer, but contains no fillers to provide colour or stabilizers. VAMAC VCS rubber appears to be the base rubber, from which the remaining members of the VAMAC product line are compounded. VAMAC VCS (also known as VAMAC MR) is a reaction product of the combination of ethylene, methyl acrylate and monomers having carboxylic acid cure sites, which once formed is then substantially free of processing aids such as the release agents octadecyl amine, complex organic phosphate esters and/or stearic acid, and anti-oxidants, such as substituted diphenyl amine.

Recently, DuPont has provided to the market under the trade designation VAMAC VMX 1012 and VCD 6200, which are rubbers made from ethylene and methyl acrylate. It is believed that the VAMAC VMX 1012 rubber possesses little to no carboxylic acid in the polymer backbone. Like the VAMAC VCS rubber, the VAMAC VMX 1012 and VCD 6200 rubbers are substantially free of processing aids such as the release agents octadecyl amine, complex organic phosphate esters and/or stearic acid, and anti-oxidants, such as substituted diphenyl amine, noted above. All of these VAMAC elastomeric polymers are useful herein.

In one variation, the so-formed reaction product is rendered substantially free of processing aids and anti-oxidants. The processing aids are release agents such as octadecyl amine (reported by Dupont™ to be available commercially from Akzo Nobel under the trade name ARMEEN® 18D), complex organic phosphate esters (reported by DuPont to be available commercially from R. T. Vanderbilt Co., Inc. under the trade name VANFRE VAM), stearic acid and/or polyethylene glycol ether wax. The anti-oxidant is a substituted diphenyl amine (reported by DuPont to be available commercially from Uniroyal Chemical under the trade name NAUGARD® 445).

Alternatively, the rubber toughening component is a dipolymer of ethylene and methyl acrylate. In one variation of this alternative, the so-formed dipolymer is rendered substantially free of processing aids and anti-oxidants. Of course, the rubber toughening agent may be a combination of the reaction product of the preceding paragraph and the dipolymer of this paragraph, either of which or both may be rendered substantially free of processing aids and anti-oxidants.

The rubber toughening component may be present in a concentration of about 1.5% to about 20% by weight based on the total weight of the composition, such as about 5% to about 15% by weight, with about 8% to about 10% being particularly desirable.

Advantageously, when the rubber toughening component is present in an amount of from about 5% to about 15% by weight based on the total weight of the composition, the compositions of the invention have enhanced flexibility and toughness.

The component containing at least two (meth)acrylate functional groups may be an aliphatic compound having at least two (meth)acrylate functional groups, preferably at the terminal ends of the aliphatic chain, though pendant along the aliphatic chain is appropriate as well, particularly where more than two (meth)acrylate functional groups are present. Alkane di- and tri-ol di- and tri-(meth)acrylates, respectively, are a few examples of such compounds. More specifically, hexanediol dimethacrylate and hexanediol diacrylate are desirable. In addition, di-trimethylolpropane tetraacrylate and trimethylolpropane trimethacrylate are also desirable.

For example the component containing at least two (meth)acrylate functional groups may have the following formula:

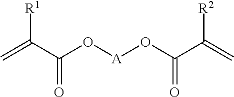

where A is a C₄ to C₃₀ aliphatic chain which can optionally comprise heteroatoms selected from O, N and S, and where the chain is optionally substituted with one or more acrylate and/or methacrylate functional groups, and/or one or more C₁-C₁₀ alkyl groups; and wherein R¹ and R² may be the same or different and are each optionally selected from H and C₁ to C₆ alkyl.

Suitably the component having at least two (meth)acrylate functional groups has the formula:

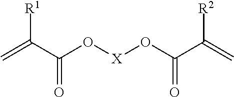

where R¹ and R² are the same or different and are selected from H or Me; and wherein X is a C₄ to C₃₀ alkyl chain which can optionally comprise heteroatoms selected from O, N and S and where the chain is optionally substituted with one or more acrylate and/or methacrylate functional groups, and/or one or more C₁-C₁₀ alkyl groups.

X may be a C₄ to C₃₀ alkyl chain, for example X may be a C₄ alkyl chain, or a C₅ alkyl chain, or a C₆ alkyl chain, or a C₇ alkyl chain, or a C₅ alkyl chain, or a Co alkyl chain, or a C₁₀ alkyl chain, or a Cu alkyl chain, or a C₁₂ alkyl chain. Suitably, X may be an alkyl chain selected from the group consisting of: butyl, pentyl, hexyl, heptyl, octyl, nonyl, decyl, undecyl, or dodecyl chain.

Suitably, such a component imparts the compositions of the invention with improved thermal performance and humid ageing performance.

The component having at least two (meth)acrylate functional groups may be selected from:

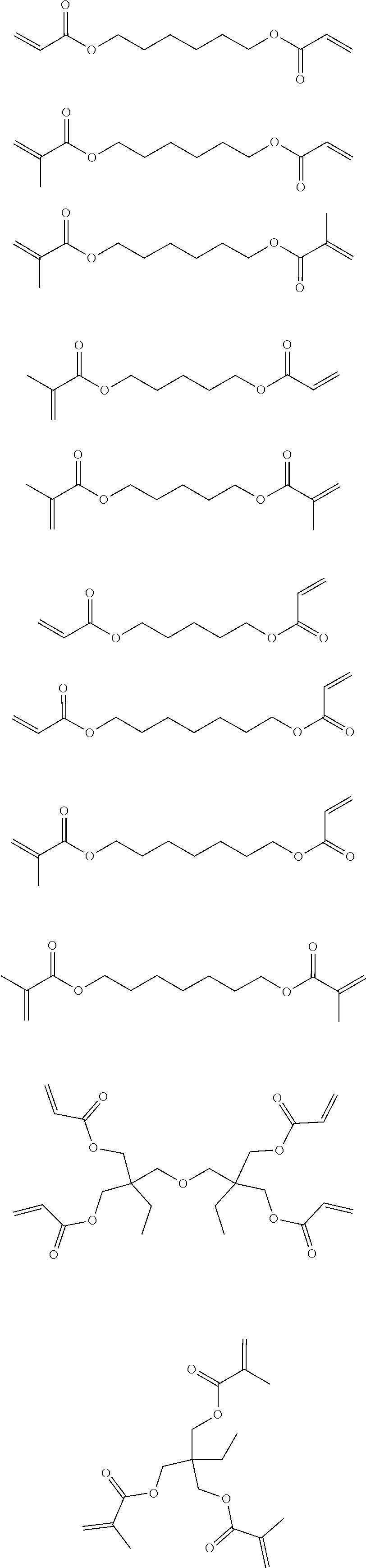

The component containing at least two (meth)acrylate functional groups may be present in a concentration of about 0.5 to about 20 wt %, such as about 1 to about 15 wt %, with about 4 to about 12 wt % being particularly desirable. When the component containing at least two (meth)acrylate functional groups is present in an amount greater than about 20 wt %, the tensile strength of the composition is reduced. When the component is present in an amount less than about 1 wt % the improvement in humid ageing is reduced. When the component is present in an amount of from about 4 to about 12 wt % the greatest enhancement in humid ageing is observed with maintenance of tensile strength performance. Advantageously, the component containing at least two (meth)acrylate functional groups acts as an active plasticiser, in addition to improving the humid ageing performance of the two-part composition, it can function as a carrier for the benzothiazole component, thereby obviating the requirement for including additional carriers.

The anhydride component may be an aromatic one like phthalic anhydride or full or partially hydrogenated versions thereof, though other anhydrides may be used with or without phthalic anhydride (or its full or partially hydrogenated versions thereof).

For example, the anhydride component may suitably be selected from phthalic anhydride, tetrahydrophthalic anhydride, 4-methylphthalic anhydride, itaconic anhydride, diphenic anhydride, phenylsuccinic anhydride, 1,8 naphthalic anhydride, bromomaleic anhydride, 2,3-dichloromaleic anhydride, 2-dodecen-1-yl-succinic anhydride, homophthalic anhydride, tetrabromophthalic anhydride, bicyclo[2, 2,2]oct-7-ene 2, 3, 5,6-tetracarboxylic dianhydride, 3-fluorophthalic anhydride, 3, 3, 4,4-benzophenone tetracarboxylic dianhydride, 3-nitrophthalic anhydride, 3, 3, 4,4-biphenyltetracarboxylic dianhydride, pyromellitic dianhydride, 1, 4, 5,8 naphthalene tetracarboxylic dianhydride, methacrylic anhydride, citraconic anhydride, hexahydro-4-methylphthalic anhydride, maleic anhydride, 2,3-diphenylmaleic anhydride, hexafluoroglutaric anhydride, 2,3-dimethylmaleic anhydride, tetrafluorophthalic anhydride, 1,2-cyclohexanedicarboxylic anhydride, glutaric anhydride, bromomaleic anhydride, 1, 4,5,8-naphthalenetetracarboxylicacid dianhydride, 1, 2,4-benzenetricarboxylic anhydride, exo-3,6-epoxy-1, 2, 3, 6-tetrahydrophthalic anhydride, di-O-acetyl-L-tartaric anhydride, 1, 2, 4,5-benzenetetracarboxylic dianhydride, 1, 2,4-benzenetricarboxylic anhydride and combinations thereof. Suitably, the anhydride component is phthalic anhydride, tetrahydrophthalic anhydride, itaconic anhydride or 4-methylphthalic anhydride.

The anhydride component may be present in a concentration of about 0.1 to about 5 wt %, such as about 0.1 to about 2 wt %, with about 0.5 wt % based on the total weight of the composition being particularly desirable. When the anhydride component is present in a concentration of greater than about 5 wt % based on the total weight of the composition no further improvement in performance is observed. When the anhydride component is present in less than 0.1 wt % based on the total weight of the composition, the improvement in humid ageing performance is not as pronounced.

Thermal resistance conferring agents may also be added. Included among such agents are certain sulfur-containing compounds, such as sulfonates, sulfinates, sulfates and sulfites as set forth in U.S. Pat. No. 5,328,944 (Attarwala), the disclosure of which is hereby expressly incorporated herein by reference.

For example, compositions of the invention may optionally comprise additives which confer thermal resistance properties such as 2-sulfobenzoic acid anhydride, triethylene glycol di(p-toluene sulfonate), trifluoroethyl p-toluene sulfonate, dimethyl dioxolen-4-ylmethyl p-toluene sulfonate, p-toluene sulfonic anhydride, methanesulfonic anhydride, 1,3 propylene sulfite, dioxathiolane dioxide, 1,8-naphthosultone, sultone 1,3-propane, sultone 1,4-butene, allyl phenyl sulfone, 4-fluorophenyl sulfone, dibenzothiophene sulfone, bis(4-fluorophenyl) sulfone, ethyl p-toluenesulfonate, and trifluoromethanesulfonic anhydride.

Accelerators may be included in the inventive cyanoacrylate compositions, such as any one or more selected from calixarenes and oxacalixarenes, silacrowns, crown ethers, cyclodextrins, poly(ethyleneglycol) di(meth)acrylates, ethoxylated hydric compounds and combinations thereof.

Of the calixarenes and oxacalixarenes, many are known, and are reported in the patent literature. See e.g. U.S. Pat. Nos. 4,556,700, 4, 622, 414, 4, 636, 539, 4, 695, 615, 4, 718, 966, and 4,855, 461, the disclosures of each of which are hereby expressly incorporated herein by reference.

For instance, as regards calixarenes, those within the following structure are useful herein:

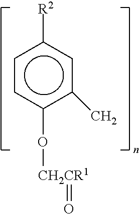

where R¹ is C₁₋₁₀ alkyl, C₁₋₁₀ alkoxy, substituted C₁₋₁₀ alkyl or C₁₋₁₀ substituted alkoxy; R² is H or C₁₋₁₀ alkyl; and n is 4, 6 or 8.

One particularly desirable calixarene is tetrabutyl tetra[2-ethoxy-2-oxoethoxy]calix-4-arene.

A host of crown ethers are known. For instance, examples which may be used herein either individually or in combination, or in combination with other first accelerator include 15-crown-5,18-crown-6, dibenzo-18-crown-6, benzo-15-crown-5-dibenzo-24-crown-8, dibenzo-30-crown-10, tribenzo-18-crown-6, asym-dibenzo-22-crown-6, dibenzo-14-crown-4, dicyclohexyl-18-crown-6, dicyclohexyl-24-crown-8, cyclohexyl-12-crown-4, 1,2-decalyl-15-crown-5, 1,2-naphtho-15-crown-5, 3, 4,5-naphtyl-16-crown-5, 1,2-methyl-benzo-18-crown-6, 1,2-methylbenzo-5,6-methylbenzo-18-crown-6, 1,2-t-butyl-18-crown-6, 1,2-vinylbenzo-15-crown-5, 1,2-vinylbenzo-18-crown-6, 1,2-t-butyl-cyclohexyl-18-crown-6, asym-dibenzo-22-crown-6 and 1,2-benzo-1,4-benzo-5-oxygen-20-crown-7. See U.S. Pat. No. 4,837,260 (Sato), the disclosure of which is hereby expressly incorporated here by reference.

Of the silacrowns, again many are known, and are reported in the literature. For instance, a typical silacrown may be represented within the following structure:

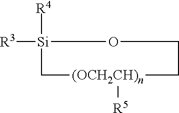

where R³ and R⁴ are organo groups which do not themselves cause polymerization of the cyanoacrylate monomer, R⁵ is H or CH₃ and n is an integer of between 1 and 4. Examples of suitable R³ and R⁴ groups are R groups, C₁₋₂₀ alkoxy groups, such as methoxy, and aryloxy groups, such as phenoxy. The R³ and R⁴ groups may contain halogen or other substituents, an example being trifluoropropyl. However, groups not suitable as R⁴ and R⁵ groups are basic groups, such as amino, substituted amino and alkylamino.

Specific examples of silacrown compounds useful in the inventive compositions include:

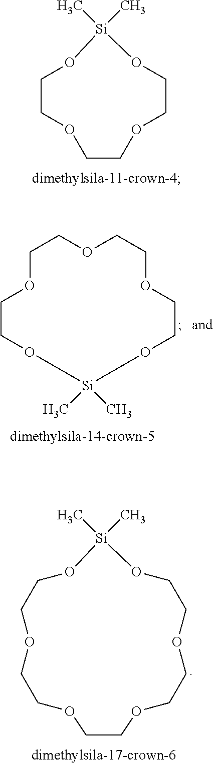 [SMILES: C[Si]1(C)OCCOCCOCCO1 ; C[Si]1(C)OCCOCCOCCOCCO1 ; C[Si]1(C)OCCOCCOCCOCCOCCO1]

See e.g. U.S. Pat. No. 4,906,317 (Liu), the disclosure of which is hereby expressly incorporated herein by reference.

Many cyclodextrins may be used in connection with the present invention. For instance, those described and claimed in U.S. Pat. No. 5,312,864 (Wenz), the disclosure of which is hereby expressly incorporated herein by reference, as hydroxyl group derivatives of an α, β or γ-cyclodextrin which is at least partly soluble in the cyanoacrylate would be appropriate choices.

For instance, poly(ethylene glycol)di(meth)acrylates suitable for use herein include those within the following structure:

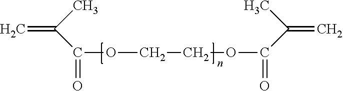

where n is greater than 3, such as within the range of 3 to 12, with n being 9 as particularly desirable. More specific examples include PEG 200 DMA, (where n is about 4) PEG 400 DMA (where n is about 9), PEG 600 DMA (where n is about 14), and PEG 800 DMA (where n is about 19), where the number (e.g., 400) represents the average molecular weight of the glycol portion of the molecule, excluding the two methacrylate groups, expressed as grams/mole (i.e., 400 g/mol). A particularly desirable PEG DMA is PEG 400 DMA.

And of the ethoxylated hydric compounds (or ethoxylated fatty alcohols that may be employed), appropriate ones may be chosen from those within the following structure:

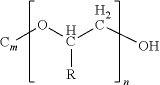

where Cₘ can be a linear or branched alkyl or alkenyl chain, m is an integer between 1 to 30, such as from 5 to 20, n is an integer between 2 to 30, such as from 5 to 15, and R may be H or alkyl, such as C₁₋₆ alkyl.

Commercially available examples of materials within the above structure include those offered under the DEHYDOL® tradename from BASF SE, Ludwigshafen, Germany.

When used, the accelerator embraced by the above structures may be included in the compositions in an amount within the range of from about 0.01% to about 10% by weight, with the range of about 0.1 to about 0.5% by weight being desirable, and about 0.4% by weight of the total composition being particularly desirable.

A stabilizer package is also ordinarily found in cyanoacrylate compositions. The stabilizer package may include one or more free radical stabilizers and anionic stabilizers, each of the identity and amount of which are well known to those of ordinary skill in the art. See e.g. U.S. Pat. Nos. 5,530,037 and 6,607,632, the disclosures of each of which are hereby incorporated herein by reference.

Commonly used free-radical stabilizers include hydroquinone, while commonly used anionic stabilizers include boron triflouride, boron trifluoride-etherate, sulphur trioxide (and hydrolyis products thereof), sulfur dioxide and methane sulfonic acid.

Other additives may be included to confer additional physical properties, such as improved shock resistance (for instance, citric acid), thickness (for instance, polymethyl methacrylate), thixotropy (for instance fumed silica), and color.

These other additives may be used in the compositions individually in an amount from about 0.05% to about 20%, such as about 1% to 15%, desirably 5% to 10% by weight, depending of course on the identity of the additive. For instance, and more specifically, citric acid may be used in the inventive compositions in an amount of 5 to 500 ppm, desirably 10 to 100 ppm.

The method of bonding substrates that are underwater comprises applying, underwater a composition as disclosed herein to at least one substrate and allowing the composition to cure.

The nozzle life may be at least 4 minutes, for example at least 5 minutes. This means that the composition will not cure in this time in a nozzle which is used to dispense while the composition is being applied. It is possible that a thin layer of the composition may cure at a nozzle tip where the composition is in contact with the water. The bulk of the composition in a nozzle body which is not in contact with water will remain uncured. It will still be possible to dispense the composition from the nozzle as the composition has a good nozzle life underwater.

Beneficially the composition may be exposed to water for up to 45 seconds prior to joining the surface of the second substrate with the coated surface of the first substrate and the composition will remain uncured so that is possible to form a bond between the substrates.

The method comprises curing the composition underwater. The composition is not removed from water to cure. When cured the bond formed is strong. When cured the bond formed retains its strength over time making the method of the invention suitable for bonding substrates for long periods of time. The bond may have a shear strength, as measured according to ASTM D1002, of at least 0.6 N/mm-after curing for five minutes, for example after curing for 24 hours, for example after 168 hours. It is possible to achieve this bond strength with difficult to bond materials such as calcium carbonate. Beneficially bonding calcium carbonate for long periods of time, for example 168 hours, makes the method suitable for applications in coral reefs, for example for coral transplantation. The strength of the bond achieved may be greater than the failure point of the calcium carbonate which means that the calcium carbonate will break before the bond breaks. The bond may have a shear strength, as measured according to ASTM D1002, of at least 4 N/mm-after curing for five minutes, for example after curing for 24 hours, for example after 168 hours. It is possible to achieve bonds with higher shear strengths on substrates with higher shear strengths as the substrate will not fail before the bond fails. For example metals, for example steels, for example grit blasted mild steel (GBMS) have higher shear strengths than the bond formed by the method and may have a shear strength, as measured according to ASTM D1002, of at least 4 N/mm² after curing for five minutes, for example after curing for 24 hours, for example after 168 hours.

### Examples

In brief the bonding of the parts to be tested was performed as follows. The parts were submerged in water, such that the water was in contact with all surfaces of the parts. The parts were fully submerged. The parts were not removed from the water prior to application of the adhesive.

The components of representative compositions are specified in Table 1.

TABLE 1

| Composition | |
|---|---|
| 1 | 2 |
| Amt (% wt) | Amt (% wt) |

Part A

| | | |
|---|---|---|
| Flexible CA | 98.5 | 98.5 |
| Tetrafluoroisophthalonitrile (TFIPN) | 1 | 1 |
| Itaconic anhydride | 0.5 | |
| 4-methylphthalic anhydride | | 0.5 |

Part B

| | | |
|---|---|---|
| Hexanediol diacrylate (HDDA) | 97.75 | 97.75 |
| Silica | 2 | 2 |
| 5-chloro-2-methylbenzothiazole | 0.25 | 0.25 |

The flexible CA component comprises: ethyl-2-cyanoacrylate, a rubber toughening agent comprised of (i) reaction products of the combination of ethylene, methyl acrylate and monomers having carboxylic acid cure sites, (ii) dipolymers of ethylene and methyl acrylate, and combinations of (i) and (ii), and a stabilizer. The rubber toughening agent used may be any of those described herein, though in this example it is the one provided under the trade name VAMAC® VCS 5500. The stabilizer used here is a combination of methane sulfonic acid and SO2. The ethyl-2-cyanoacrylate is present in greater than 80 wt % and the rubber toughening agent is present in 6 wt % based on the total weight of the flexible CA composition. In the compositions of Table 1 the ratio of the first part (Part A) to the second part (Part B) is 10:1, although other ratios could also be used.

The composition was dispensed from a container and applied to a first part. A second part was overlapped by one inch (2.54 cm) and the parts were clamped together so that the adhesive cured to form a bond between the parts. The amount of time between dispensation from the container and overlapping the second part is the open time. Both the application of the adhesive and curing of the adhesive were performed underwater. For testing dry parts the parts were not placed underwater. The parts were dry, that is free from surface moisture, when the adhesive was applied and when the adhesive was cured. The shear strength of the bond was measured according to ASTM D1002.

The following substrates were tested: Grit-blasted mild steel (GBMS), calcium carbonate.

### Results

GBMS parts were bonded with an open time of 0 seconds. That is the composition was applied to the parts and the parts were immediately joined together. The parts were not removed from the water while the adhesive cured. The bond was cured while fully submerged underwater. The adhesive achieved a good handling strength after curing for 5 minutes as shown in Table 2. The strength of the bond when the adhesive is applied and cured underwater is comparable to the strength of the bond achieved on dry parts. This strength allows the bonded parts to be handled without the bond breaking. The strength of the composition applied and cured underwater was comparable to the strength achieved by the adhesive which is applied to dry parts. After curing for 24 hours the bond strength was maintained as shown in Table 2. After curing for 168 hours the bond strength was maintained as shown in Table 2.

GMBS parts were bonded with an open time of 0 seconds (where the composition was applied and the parts were joined together immediately), 30 seconds (where the composition was applied and the parts were joined together after 30 seconds), and 45 seconds (where the composition was applied and the parts were joined together after 45 seconds). The adhesive was applied underwater and the parts were subsequently removed from the water and cured in air for 24 hours. The adhesive formed a strong bond when exposed even after exposure to water for 45 seconds. As shown in Table 3 with an open time of 0 seconds, 30 seconds, and 45 seconds a strong bond was formed after the 24 hours.

Calcium carbonate parts were bonded with an open time of 0 seconds. The parts were not removed from the water while the adhesive cured. The bond was cured while fully submerged underwater. The adhesive achieved a good handling strength after curing for 5 minutes as shown in Table 2. The strength of the bond when the adhesive is applied and cured underwater is comparable to the strength of the bond achieved on dry parts. The tensile strength of calcium carbonate is approximately 1 N/mm² so the parts may fail while the bond remains unbroken. This strength allows the bonded parts to be handled without the bond breaking. The strength of the composition applied and cured underwater was comparable to the strength achieved by the adhesive which is applied to dry parts. After curing for 24 hours the bond strength was maintained as shown in Table 2. After curing for 168 hours the bond strength was maintained as shown in Table 2.

Calcium carbonate parts were bonded with an open time of 0 seconds (where the composition was applied and the parts were joined together immediately), 30 seconds (where the composition was applied and the parts were joined together after 30 seconds), and 45 seconds (where the composition was applied and the parts were joined together after 45 seconds). The adhesive was applied underwater and the parts were subsequently removed from the water and cured in air for 24 hours. The adhesive formed a strong bond when exposed even after exposure to water for 45 seconds. As shown in Table 3 with an open time of 0 seconds, 30 seconds, and 45 seconds a strong bond was formed after the 24 hours. The tensile strength of calcium carbonate is approximately 1 N/mm² so the parts may fail while the bond remains unbroken.

TABLE 2

| | | Shear strength N/mm² | | | |
|---|---|---|---|---|---|
| | | GMBS | | Calcium carbonate | |
| Cure time | | Dry parts | Underwater | Dry parts | Underwater |
| 5 | minutes | 7.5 | 5.4 | 0.8 | 0.8 |
| 24 | hours | 17.8 | 5.4 | 1 | 0.9 |
| 168 | hours | 20.3 | 8.1 | 1.3 | 1.1 |

TABLE 3

| | |
|---|---|
| Underwater Open | Shear strength N/mm² after 24 hours |

| time (seconds) | GMBS | Calcium carbonate |
|---|---|---|
| 0 | 5.6 | 0.9 |
| 30 | 4.6 | 0.7 |
| 45 | 4.2 | 0.9 |

The nozzle life of the packaging of the adhesive underwater is greater than 5 minutes when the adhesive is dispensed every 2 minutes or less. Table 4 shows that the adhesive composition was easily dispensed and did not block the nozzle after 5 minutes. The adhesive composition was easily extruded from the nozzle at 0 minutes, that is, when the nozzle was first open to the water. After 1 minute of being open to the water the composition was easily extruded from the nozzle. The nozzle being underwater did not prevent the dispensing of the composition. After an additional minute underwater (2 minutes) the composition was easily dispensed from the nozzle. After an additional minute underwater (3 minutes) the composition was easily dispensed from the nozzle. After an additional 2 minutes underwater (5 minutes) the tip of the nozzle required cleaning as the surface of the composition had begun to cure. There was no bulk cure of the composition, only a thin layer of composition had begun to cure. The tip of the nozzle was cleaned to remove the cured layer and the composition was easily dispensed from the nozzle as no bulk cure had occurred.

TABLE 4

| Time (min) | Nozzle life |
|---|---|
| 0 | Easily dispensed |
| 1 | Easily dispensed |
| 2 | Easily dispensed |
| 3 | Easily dispensed |
| 5 | Tip cleaning needed, easily dispensed |

The words “comprises/comprising” and the words “having/including” when used herein with reference to the present invention are used to specify the presence of stated features, integers, steps or components but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

What is claimed is:

1. A method of bonding substrates that are underwater comprising:
applying, underwater, a cyanoacrylate composition to at least one substrate, wherein the cyanoacrylate composition comprises:
(a) a first part comprising:
a cyanoacrylate component and a rubber toughening agent, the rubber toughening agent comprised of (i) reaction products of the combination of ethylene, methyl acrylate and monomers having carboxylic acid cure sites, (ii) dipolymers of ethylene and methyl acrylate, and combinations of (i) and (ii); and
(b) a second part comprising:
a 2-substituted benzothiazole or derivative thereof, wherein the 2-substituent is a C₁₋₂₀ alkyl, a C₂₋₂₀ alkene, a C₈₋₂₀ alkylbenzyl, a C₁₋₂₀ alkylamino, a C₁₋₂₀ alkoxy, a C₁₋₂₀ alkylhydroxy, an ether, a sulfenamide, a C₁₋₂₀ thioalkyl or a C₁₋₂₀ thioalkoxy group; and
wherein at least one of the first or second part further comprises:
a component containing at least two (meth)acrylate functional groups,
at least one benzonitrile compound substituted with at least two or more electron withdrawing groups selected from halo, —NO₂, or —CN and combinations thereof, and
at least one anhydride component, and
allowing the composition to cure underwater.

2. The method of claim 1 wherein the cyanoacrylate component of the cyanoacrylate composition is selected from materials within the structure H₂C═C(CN)—COOR, wherein R is selected from C₁₋₁₅ alkyl, C₂₋₁₅ alkoxyalkyl, C₃₋₁₅ cycloalkyl, C₂₋₁₅ alkenyl, C₆₋₁₅ aralkyl, C₅₋₁₅ aryl, C₃₋₁₅ allyl and C₁₋₁₅ haloalkyl groups.

3. The method of claim 1 wherein the 2-substituted benzothiazole of the cyanoacrylate composition is further substituted with at least one halo substituent, C₁₋₂₀ thioalkyl, C₁₋₂₀ haloalkyl, C₁₋₂₀ alkyl, C₁₋₂₀ alkoxy or hydroxyl substituent.

4. The method of claim 3 wherein the halo substituent of the cyanoacrylate composition is Cl, F or Br.

5. The method of claim 1 wherein the 2-substituted benzothiazole of the cyanoacrylate composition is selected from the group consisting of:
5-chloro-2-methyl benzothiazole, 5-bromo-2-methyl-1,3-benzothiazole, 2-[(tert-butylamino)thio]-1,3-benzothiazol-5-ol, 5, 6-dichloro-2-methyl-1, 3-benzothiazole, 6-bromo-2-methyl-1, 3-benzothiazole, 5-fluoro-2-methyl-1, 3-benzothiazole, 6,7-dichloro-2-methyl-1, 3-benzothiazole, 2, 5-dimethyl-1, 3-benzothiazole, 4, 5, 6, 7-tetrafluoro-2-methyl-1, 3-benzothiazole, 4, 5, 6, 7-tetrafluoro-2-methyl-1, 3-benzothiazole, 2-(allyloxy)-1, 3-benzothiazole 2-methyl-5-(methylthio)-1, 3-benzothiazole, 2-(ethylthio)-1, 3-benzothiazole, 2-(hexyloxy)-1, 3-benzothiazole, 2-(1, 3-dimethylbutoxy)-1, 3-benzothiazole, 2-(Octadecylthio) benzothiazole, 2-(1-ethylbutoxy)-1, 3-benzothiazole, 2-(octyloxy)-1, 3-benzothiazole, 2-(1-methylbutoxy)-1, 3-benzothiazole, 2-(2-phenylethoxy)-1, 3-benzothiazole, 2-[(1-methylheptyl)oxy]-1, 3-benzothiazole 2-allyl-1, 3-benzothiazole, 2-[(1-methylhexyl)oxy]-1, 3-benzothiazole, 4-chloro-2-methoxy-1, 3-benzothiazole, 2-(3-methylbutoxy)-1, 3-benzothiazole, 4-chloro-2-(ethynyloxy)-1, 3-benzothiazole, 2, 5, 6-trimethyl-1, 3-benzothiazole, 4-methoxy-2,7-dimethyl-1, 3-benzothiazole, 5, 6-dimethoxy-2-methyl-1, 3-benzothiazole, 2,5, 7-trimethyl-1, 3-benzothiazole, 2-(butylthio)-1, 3-benzothiazole, 5-chloro-2-(ethylthio)-1, 3-benzothiazole, 2-methyl-1, 3-benzothiazole, 2-(undecylthio)-1, 3-benzothiazole, 2-methyl-1, 3-benzothiazole 5-methoxy-2-methylbenzothiazole, 2, 5-dimethylbenzothiazole 6-methoxy-2-methylbenzothiazole, 2-methyl-5-benzothiazolol, 2-(methylmercapto)-benzothiazole, and 2-[(cyclohexylamino)thio]-benzothiazole).

6. The method of claim 1 wherein the component containing at least two (meth)acrylate functional groups of the cyanoacrylate composition is represented by the formula: 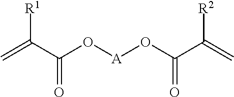
wherein A is a C₄ to C₃₀ aliphatic chain which can optionally comprise heteroatoms selected from the group consisting of O, N and S;
wherein said chain is optionally substituted with one or more acrylate or methacrylate functional groups, and/or one or more C₁-C₁₀ alkyl groups; and
wherein R¹ and Re may be the same or different and are each optionally selected from the group consisting of H and C₁ to C₆ alkyl.

7. The method of claim 1 wherein the component containing at least two (meth)acrylate functional groups of the cyanoacrylate composition is selected from the group consisting of hexane diol diacrylate, hexane diol dimethacrylate, and di-trimethylolpropane tetraacrylate and combinations thereof.

8. The method of claim 1 wherein the component containing at least two (meth)acrylate functional groups of the cyanoacrylate composition is in the second part (b).

9. The method of claim 1 wherein the anhydride component of the cyanoacrylate composition is selected from the group consisting of: phthalic anhydride, tetrahydrophthalic anhydride, 4-methylphthalic anhydride, itaconic anhydride, diphenic anhydride, phenylsuccinic anhydride, 1,8 naphthalic anhydride, bromomaleic anhydride, 2,3-dichloromaleic anhydride, 2-dodecen-1-yl-succinic anhydride, homophthalic anhydride, tetrabromophthalic anhydride, bicyclo[2,2, 2]oct-7-ene 2,3, 5, 6-tetracarboxylic dianhydride, 3-fluorophthalic anhydride, 3,3, 4, 4-benzophenone tetracarboxylic dianhydride, 3-nitrophthalic anhydride, 3,3, 4, 4-biphenyltetracarboxylic dianhydride, pyromellitic dianhydride, 1,4,5,8 naphthalene tetracarboxylic dianhydride, methacrylic anhydride, citraconic anhydride, hexahydro-4-methylphthalic anhydride, maleic anhydride, 2,3-diphenylmaleic anhydride, hexafluoroglutaric anhydride, 2, 3-dimethylmaleic anhydride, tetrafluorophthalic anhydride, 1,2-cyclohexanedicarboxylic anhydride, glutaric anhydride, bromomaleic anhydride, 1,4,5,8-naphthalenetetracarboxylicacid dianhydride, 1, 2,4-benzenetricarboxylic anhydride, Exo-3, 6-epoxy-1, 2, 3, 6-tetrahydrophthalic anhydride, di-O-acetyl-L-tartaric anhydride, 1,2, 4, 5-benzenetetracarboxylic dianhydride, 1, 2, 4-benzenetricarboxylic anhydride and combinations thereof.

10. The method of claim 1 wherein the benzonitrile compound of the cyanoacrylate composition is selected from the group consisting of: tetrafluoroisophthalonitrile, 3,5-dinitrobenzonitrile; 2-chloro-3, 5-dinitrobenzonitrile;
pentafluorobenzonitrile; α,α,α-2-tetrafluoro-p-tolunitrile; and
tetrachloroterephthalonitrile and combinations thereof.

11. The method of claim 1 wherein the benzonitrile compound of the cyanoacrylate composition is present in an amount of from 0.05 to 5 wt %, based on the total weight of the composition.

12. The method of claim 1 wherein the anhydride component of the cyanoacrylate composition is present in an amount of from 0.1 to 5 wt % based on the total weight of the composition.

13. The method of claim 1 wherein the component containing at least two (meth)acrylate functional groups of the cyanoacrylate composition is present in an amount of from 1 to 20 wt % based on the total weight of the composition.

14. The method of claim 1 wherein the 2-substituted benzothiazole of the cyanoacrylate composition is 5-chloro-2-methyl benzothiazole, the anhydride is selected from the group consisting of phthalic anhydride, tetrahydrophthalic anhydride, itaconic anhydride, 4-methylphthalic anhydride and combinations thereof, and wherein the at least one benzonitrile compound is selected from the group consisting of tetrafluoroisophthalonitrile or pentafluorobenzonitrile and combinations thereof.

15. The method of claim 14 wherein the benzonitrile of the cyanoacrylate composition is present in an amount of from 0.1 to 1 wt %, the anhydride is present in an amount of from 0.1 to 2 wt %, and the component containing at least two (meth)acrylate functional groups is present in an amount of from 4 to 12 wt %, based on the total weight of the composition.

16. The method of claim 1 wherein the cyanoacrylate composition further comprises an accelerator component selected from the group consisting of calixarene, oxacalixarene, silacrown, cyclodextrin, crown ether, poly(ethyleneglycol)di(meth)acrylate, ethoxylated hydric compound, and combinations thereof.

17. The method of claim 16 wherein the accelerator component comprises a calixarene which is tetrabutyl tetra[2-ethoxy-2-oxoethoxy]calix-4-arene.

18. The method of claim 16, wherein the accelerator component comprises a crown ether which is selected from the group consisting of 15-crown-5, 18-crown-6, dibenzo-18-crown-6, benzo-15-crown-5-dibenzo-24-crown-8, dibenzo-30-crown-10, tribenzo-18-crown-6, asym-dibenzo-22-crown-6, dibenzo-14-crown-4, dicyclohexyl-18-crown-6, dicyclohexyl-24-crown-8, cyclohexyl-12-crown-4, 1, 2-decalyl-15-crown-5, 1, 2-naphtho-15-crown-5,3, 4, 5-naphtyl-16-crown-5, 1, 2-methyl-benzo-18-crown-6, 1, 2-methylbenzo-5, 6-methylbenzo-18-crown-6, 1, 2-t-butyl-18-crown-6, 1, 2-vinylbenzo-15-crown-5, 1, 2-vinylbenzo-18-crown-6, 1, 2-t-butyl-cyclohexyl-18-crown-6, asym-dibenzo-22-crown-6, 1, 2-benzo-1, 4-benzo-5-oxygen-20-crown-7 and combinations thereof.

19. The method of claim 16 wherein the accelerator component comprises a poly(ethyleneglycol) di(meth)acrylate which is within the following structure: 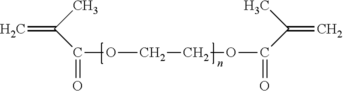
wherein n is greater than 3.

20. The method of claim 1 wherein the cyanoacrylate component further comprises additives selected from the group consisting of: shock resistant conferring additives, thixotropy conferring agents, thickeners, dyes, thermal degradation resistance enhancers, and combinations thereof.

21. The method of claim 20 wherein the shock resistant conferring additive is citric acid.

22. The method of claim 1 wherein the cyanoacrylate component further comprises at least one additive selected from the group consisting of:
2-sulfobenzoic acid anhydride, triethylene glycol di(paratoluene sulfonate), trifluoroethyl para-toluene sulfonate, dimethyl dioxolen-4-ylmethyl para-toluene sulfonate, paratoluene sulfonic anhydride, methane sulfonic anhydride, 1,3-propylene sulfite, dioxathiolane dioxide, 1, 8-naphthosultone, sultone 1,3-propane, sultone 1,4-butene, allyl phenyl sulfone, 4-fluorophenyl sulfone, dibenzothiophene sulfone, bis(4-fluorophenyl) sulfone, ethyl p-toluenesulfonate, trifluoromethanesulfonic anhydride, ethylene sulphite and combinations thereof.

23. The method of claim 22 wherein the additive is selected from 1,8-naphthosultone and ethylene sulphite, and combinations thereof.

24. A method of bonding substrates that are underwater comprising:
applying, underwater, a cyanoacrylate composition to at least one substrate, wherein the cyanoacrylate composition comprises:
(a) a first part comprising:
a cyanoacrylate component and a rubber toughening agent, the rubber toughening agent comprised of (i) reaction products of the combination of ethylene, methyl acrylate and monomers having carboxylic acid cure sites, (ii) dipolymers of ethylene and methyl acrylate, and combinations of (i) and (ii); and
(b) a second part comprising:
a 2-substituted benzothiazole or derivative thereof, wherein the 2-substituent is a C₁₋₂₀ alkyl, a C₂₋₂₀ alkene, a C₈₋₂₀ alkylbenzyl, a C₁₋₂₀ alkylamino, a C₁₋₂₀ alkoxy, a C₁₋₂₀ alkylhydroxy, an ether, a sulfenamide, a C₁₋₂₀ thioalkyl or a C₁₋₂₀ thioalkoxy group; and
wherein at least one of the first or second part further comprises an anhydride component; and
wherein the second part further comprises:
a component containing at least two (meth)acrylate functional groups which is present in an amount of from 1 to 20 wt %, based on the total weight of the composition; and
at least one benzonitrile compound substituted with at least two or more electron withdrawing groups selected from halo, —NO₂, or —CN and combinations thereof, and
allowing the composition to cure underwater.

25. The method of claim 24 wherein the 2-substituted benzothiazole of the cyanoacrylate composition is selected from the group consisting of: 5-chloro-2-methyl benzothiazole, 2-methyl-1, 3-benzothiazole, 2-(methylmercapto)-benzothiazole, 5-methoxy-2-methylbenzothiazole, 6-methoxybenzothiazole, 2, 5-dimethylbenzothiazole, 2-methyl-5-benzothiazolol and combinations thereof;
the anhydride component of the cyanoacrylate composition is selected from the group consisting of: tetrafluoroisophthalonitrile, 3, 5-dinitrobenzonitrile; 2-chloro-3,5-dinitrobenzonitrile; pentafluorobenzonitrile; a, a, α-2-tetrafluoro-p-tolunitrile; tetrachloroterephthalonitrile and combinations thereof; and
the component containing at least two (meth)acrylate functional groups of the cyanoacrylate composition is selected from the group consisting of hexanediol diacrylate, hexanediol dimethacrylate, di-trimethylolpropane tetraacrylate and combinations thereof.

26. The method of claim 1 wherein the cyanoacrylate composition is applied in a ratio of the first part to second part of the cyanoacrylate composition in the range of about 1:1 to about 10:1.

27. The method of claim 24 wherein the cyanoacrylate composition is applied in a ratio of the first part to second part of about 10:1.

28. The method of claim 1 wherein the component containing at least two (meth)acrylate functional groups of the cyanoacrylate composition is used as a carrier material for the at least one benzonitrile compound.

29. The method of claim 1 comprising exposing the composition to water for up to 45 seconds prior to joining the surface of the second substrate with the coated surface of the first substrate.

30. The method of claim 1 wherein curing the composition forms a bond with a shear strength of at least 0.6 N/mm² after curing for five minutes, for example after curing for 24 hours.

31. The method of claim 1 wherein curing the composition forms a bond with a shear strength of at least 4 N/mm² after curing for five minutes.

32. The method of claim 1 wherein one or both substrates is a metal, for example wherein one or both substrates is steel.

33. The method of claim 1 wherein one or both substrates comprises calcium carbonate.

34. The method of claim 1 wherein the nozzle life is at least 4 minutes.

35. An assembly comprising two underwater substrates that are bonded together by the method according to claim 1.
